(19) United States
(12) Patent Application Publication
(10) Pub. No.: US 2008/0315999 A1
(43) Pub. Date: Dec. 25, 2008

(54) Wireless communication system for tracking assets with affixed electronic smart tags and methods thereof

(75) Inventor: Michael Braiman, Netanya (IL)

Correspondence Address: KLEHR , HARRISON ET AL, 260 S. BROAD STREET, PHILADELPHIA, PA, 19102, US

(73) Assignee: Parelec Israel Ltd.

(21) Appl. No.: 11/821,744

(22) Filed: Jun. 25, 2007

(51) Int. Cl. H04B 7/005

(52) U.S. Cl. 340/10.4; 340/10.1; 340/572.1

(57) ABSTRACT

A wireless bidirectional communication system and method for tracking smart tags affixed to assets located within a defined area. Asset tracking is provided by a central processor operated by a user. The central processor combined with communication modules communicates with the system tags for deriving corresponding assets' locations. Communication is synchronized by way of broadcasting a clock generator signal over the communication link. The broadcasted clock signal is further used by the system for generating distinct time slots assigned to a tag by demand. Synchronizing the communication between the tags and the central processor is beneficial for maintaining reliable and short messages across the data link and maintaining low power draw from the tag battery.

### FIELD OF THE INVENTION

The present invention generally relates to a wireless communication system and specifically to a wireless tracking communication system and methods thereof.

### BACKGROUND OF THE INVENTION

Tracking systems are widely used around the world for diversified applications in manufacturing, agriculture, transportation, shipping and security, to monitor certain objects from a control center. A tracking system commonly includes tags that are affixed to the tracked objects and each tag transmitting individual identification and momentary location data to a central processing unit. The central processing unit follows the location of each of the tracked objects and reports the data through a user interface. In applications like package delivery tracking, or inventory control, where the tags do not have to communicate with the central unit, the tags used are paper coded with Barcodes read by code readers which are providing the tag data to the tracking system. In other applications where objects have to be tracked in real-time, electronic tags are required for transmitting identification and location data to the central unit. Commonly used electronic tags are the Radio Frequency Identification (RFID) tags. An REID tag comprises low cost Radio Frequency (RF) transceiver electronics adaptable to receive an inquiry from an RFID reader and transmit identification (ID) data to the reader. Some of REID tags do not include a battery and are powered by the tag reader via transmitted electrical power. Alternatively, other RFID tags use a small battery as a power source. In any event, the power of REID tag battery is limited hence RFID tags have to maintain extremely low power consumption. Therefore, REID tags transmit only identification data while location of an RFID tag is determined by the location of one or several readers identifying the tags. The scope of electronic tag capabilities may be extended to measuring accurate location within a defined area, sensing motion, or deriving any other information relevant to a particular application. Vehicle tracking, for example, may utilize tags incorporated as Global Positioning System (GPS) receivers with by bidirectional communication link while manufacturing tracking systems associated with a smaller predefined tracking area and high locating accuracy requirements, may use tags comprising optical of Radio Frequency (RF) locating means. Regardless whether the tags use GPS receivers, optical locating means, or RF locating means, a low power and reliable bi-directional communication link is essential for effectively transferring data between the smart tags and a central unit. The communication system has to include specific features pertinent to tracking systems, like for example: having a wireless communication link interface, adaptability to optical location devices, or GPS receivers, low power consumption, low data collision rate between tags and minimum data traffic between the tags and the central unit. Smart tags for tracking systems may be configured differently according to the tracking range and tracking accuracy of the application. However, regardless of the location means used by the tag, there is a long felt need for an adequate communication link connecting smart tags to a central unit.

### SUMMARY OF THE INVENTION

It is the object of this invention to have a wireless communication system for asset tracking, comprising a central processing and communicating unit (CPCU), a plurality of tags, each tag is assigned to an asset, a wireless communication link; and a clock generator signal, wherein said clock generator signal is broadcasted over said communication link for synchronizing data exchange between said CPCU and said tags and further wherein said clock signal is utilized for creating a plurality of time slots, each of said time slots is assigned to a tag.

Another object of this invention is to disclose a wireless communication system as defined in any of the above, wherein said CPCU comprising a tag information registry database.

Another object of this invention is to disclose a wireless communication system as defined in any of the above, wherein said CPCU further comprising an application interface server.

Another object of this invention is to disclose a wireless communication system as defined in any of the above, wherein said CPCU further comprising a location server.

Another object of this invention is to disclose a wireless communication system as defined in any of the above, wherein said tags comprising wireless transmitters and receivers.

Another object of this invention is to disclose a wireless communication system as defined in any of the above, wherein said tags are by default in a sleep mode.

Another object of this invention is to disclose a wireless communication system as defined in any of the above, wherein said tags further comprising a member selected from a group consisting of light emitters, GPS receivers, motion detectors, or any combination of thereof.

Another object of this invention is to disclose a wireless communication system as defined in any of the above, wherein said CPCU comprising RF triangulation transceivers.

Another object of this invention is to disclose a wireless communication system as defined in any of the above, wherein said CPCU unit comprising at least one optical reader and a video processor.

Another object of this invention is to disclose a wireless communication system as defined in any of the above, wherein said communication link comprising at least one RF beacon adapted to cover a defined area.

The wireless communication system according to claim 1, wherein said communication link comprising at least one base station.

Another object of this invention is to disclose a wireless communication system as defined in any of the above, comprising a protocol; said protocol further comprising a physical layer, a data link layer and an application layer; said physical layer further comprising a start preamble, a synchronizing header and an application data frame.

Another object of this invention is to disclose a wireless communication system as defined in any of the above, wherein said physical layer comprising a start preamble, a synchronizing header and an application data frame,

Another object of this invention is to disclose a wireless communication system as defined in any of the above, wherein said data link layer comprising a service preamble and an application frame; wherein said service preamble further comprising parameters selected from a group consisting of data type, data length, source address, destination address or any combination thereof.

Another object of this invention is to disclose a wireless communication system as defined in any of the above, wherein said data link layer further comprising a section of a communication cycle redundancy correction (CRC) providing an error correction and operable by a checksum of at least one bit.

Another object of this invention is to disclose a wireless communication system as defined in any of the above, wherein said data frame comprising application data and parameters of application data; wherein said parameters are selected from a group consisting of data type, data length, source address, destination address or any combination thereof.

Another object of this invention is to disclose a wireless communication method, comprising: obtaining a CPCU, a plurality of tags, each tag is assigned to an asset, a wireless communication link and a clock signal;
communicating said tags with said CPCU via said communicating link, and
broadcasting a clock signal across said communicating link,
wherein said broadcasting of a clock signal is utilized for synchronizing said communicating of said tags with said CPCU and further utilized for creating a plurality of time slots; and
further wherein each of said time slots is assigned to a tag.

Another object of this invention is to disclose a wireless communication method defined in any of the above, wherein said communicating between of all said tags with said CPCU is provided during a communication cycle time.

Another object of this invention is to disclose a wireless communication method defined in any of the above, wherein said communicating during said communication cycle is divided to an uplink time section and to a downlink time section.

Another object of this invention is to disclose a wireless communication method defined in any of the above, wherein said communicating uplink time section comprising time slots associated with said tags.

Another object of this invention is to disclose a wireless communication method defined in any of the above, wherein said communicating comprising acknowledging of data receipt by said CPCU.

Another object of this invention is to disclose a wireless communication method defined in any of the above, wherein said communicating comprising a first and second operational mode, wherein said first mode is initiated by said CPCU and said second mode is initiated by any of said tags.

Another object of this invention is to disclose a wireless communication method defined in any of the above, comprising dividing said communication cycle time into time slots, wherein each said time slot is assigned to a single tag,

Another object of this invention is to disclose a wireless communication method defined in any of the above, wherein said communicating between said tags and said CPCU occurring during a plurality of cycle times.

### BRIEF DESCRIPTION OF THE FIGURES

The object and the advantages of various embodiments of the invention will become apparent from the following description when read in conjunction with the accompanying drawings wherein,

FIG. 1 schematically represents a block diagram of a tracking system according to one embodiment of the present invention;

FIG. 2 schematically represents a detailed block diagram of the wireless communication system according to one embodiment of the invention;

FIG. 3 schematically represents a timing diagram of the communication system according to another embodiment of the invention;

FIG. 4a schematically represents a system data flow communication cycle initiated by a tag according to another embodiment of the invention;

FIG. 4b schematically represents a system data flow communication cycle initiated by the application according to another embodiment of the invention; and,

FIG. 5 schematically represents the communication system stack protocol according to another embodiment of the invention;

### DETAILED DESCRIPTION OF THE EMBODIMENTS

The following description is provided alongside all chapters of the present invention, so as to enable any person skilled in the art to make use of said invention and sets forth the best modes contemplated by the inventor of carrying out this invention. Various modifications however, will remain apparent to those skilled in the art, since the generic principles of the present invention have been defined specifically to provide a wireless communication system for tracking assets and methods thereof.

The system accommodates asset management and control functions via over the air asset related data exchange. The system consists of a plurality of smart agent tags (smart tags) affixed to the assets and base stations incorporated as front end units of a bidirectional wireless communication link between the smart tags and the central unit of the system. System timing and data structures are synchronized by a single clock source transmitted over the communication link.

The system may further consist of at least one RF beacon used for locating smart tags within a predefined area and for initiating data exchange with smart tags that are most of the time in a sleep mode for minimizing power consumption of the smart tag battery. Depending on the size of the area serviced by the system and the locating accuracy requirement, the system may be configured but not limited to RF, optical or OPS measurement location devices or any combination thereof. The system architecture, data transfer timing and communication protocol are described in the subsequent sections.

The term ‘central processing and communicating unit’ (CPCU) relates to processing devices radio frequency transmitters and receivers configured for communicating with the tags and user interface.

The term ‘tag’ or ‘smart tag’ relates to an electronic device communicating transmitting location and identification to a CPCU.

The term ‘asset’ relates to an object that can be tracked by affixing a tag to it.

The term ‘wireless communication link’; EXAMPLES internet, intranet, cellular, or any other communicating means adapted to exchange data,

The term ‘clock signal’ means a digital waveform of constant frequency.

The term ‘time slice’ relates a period of time assigned for operation of a single tag.

The term ‘RE beacon’ relates to a radio transmitter that sends a characteristic signal used for locating.

The term ‘information registration module’ is a data base used by the central unit to record tag information.

The term ‘uplink’ relates to data transmitted from the tags to the central unit.

The term ‘downlink’ relates to data transmitted from the central unit to the tags.

The term ‘optical reader’ relates commonly to a video camera.

The term ‘communication cycle’ is the repeatable cycle time during which the central unit communicates with all the system tags and updates the tags database.

The term ‘Tag originated Mode’ relates to a communicating mode initiated by a tag.

The term ‘System originated Mode’ relates to a communicating mode initiated by an enquiry of the central unit.

The term ‘TSR’ is Tag Service Request.

The term ‘TIR’ is Tag Information Registry.

The term ‘Cyclic Redundancy Correction (CRC) relates to a number derived from data, and transmitted with the data in order to detect errors.

The term ‘protocol stack’ is software implementation of a computer networking protocol.

The term ‘Application Interface Server (API)’ is related to the user interface terminal.

The term ‘Location server’ relates to processing function of the CPCU,

The term ‘radio frequency triangulation transceivers’ relates to a radio frequency location measurement by intersecting direction of two radio frequency beams reflected from an object.

The term ‘base station’ relates to the units providing the radio frequency front end to the wireless communication link.

The term ‘application data frame’ is the section of data in the application layer of the communication protocol.

The term ‘acknowledge’ relates to a confirmation response transmitted by the CPCU to the tags indicating correct reception of data,

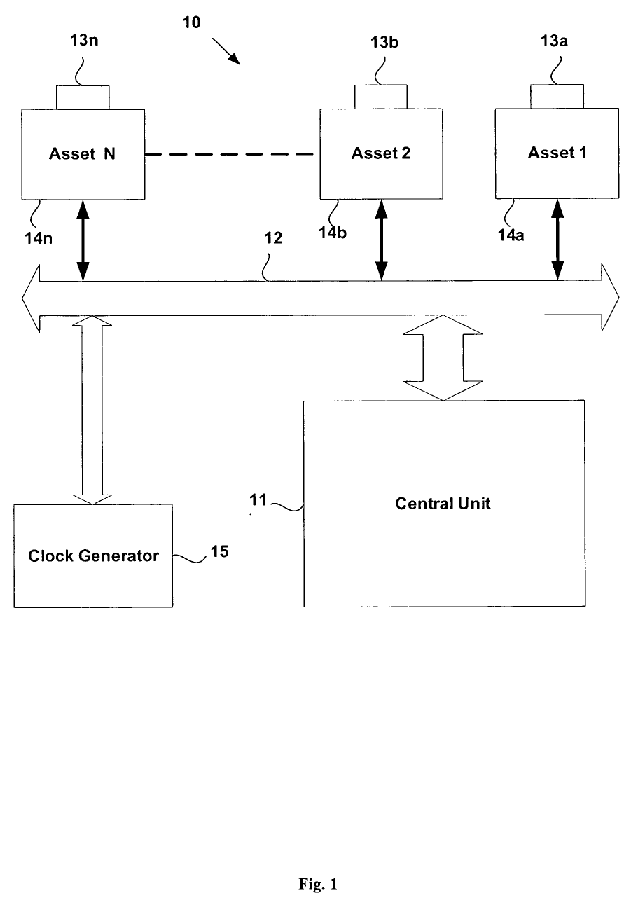

Reference is now made to FIG. 1 schematically illustrating a block diagram of a system according to one embodiment of the present invention. An asset location and control system 10 consists of a central control and processing unit 11 connected via a wireless communication link 12 to a plurality of similar smart agent tags 13a, 13b and 13n affixed respectively to assets 14a, 14b, and 14n. Data communication between the smart tags and the central unit 11, consisting of inquiries initiated by the central unit and local data sent by each of the smart tags, is sustained continuously. The central unit 11 may include but is not limited to base stations, RE beacons, servers and an application processor configured to be adaptable to smart tag operation and for data exchange between the smart tags and the and an application module. Smart tag data including asset location, identification and motion, or further required information, is used by the system for monitoring the assets within a user defines area. A single clock generator 15 generates a clock signal that synchronizes all the smart tags with the central unit by broadcasting the clock over the communication link. System synchronization enables defining time slots assigned to a tag operation on demand and thus minimizing or even avoiding conflicting transmission circumstances (collisions) between the smart tags. Furthermore, the robustness of synchronous data transfer and staying away from repeated data transmissions leads to short data transfer messages and hence to saving the power of a smart tag battery,

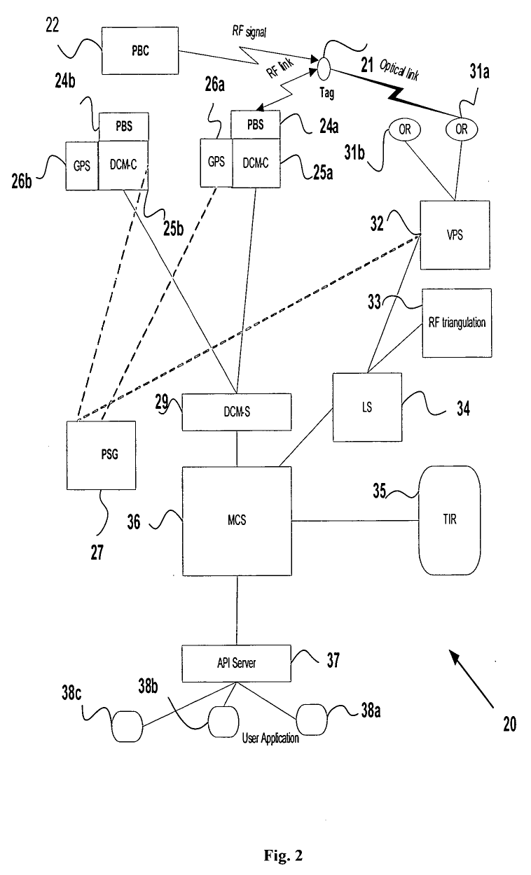

Reference is now made to FIG. 2 schematically illustrating a detailed block diagram of the system architecture. System 20 is depicted with a single tag 21 representative of all the smart tags of the system, connected to the central unit incorporated by several parts. At least one RE beacon 22, operating within a defined range of the system area, is used to transmit wakeup calls via RF link 23 to tag 21 which may be in a sleep mode. RE beacon 22 may also transmit to the central processor the associated coverage area which is included within the tracking area of the system. RF transceivers of base station units 24a and 24b provide the communication link between smart tags and the central processor. Each base station unit is connected to a data communication module 25a and 25b comprising client and server units. Each base station unit is further connected to a GPS receiver 26a and 26b providing base station location data to the central unit. Data communication modules 25a and 25b connected the associated base station units 24a and 24b are communicating with a mediation control server 36 via data communication unit 29. Mediation control server 36 which is the processor of the central unit carries out the system operation algorithm and the user application interface. The mediation control server receives location data from a location server 34 and stores all the pertinent data of the tags in a database defined as tag information registration module 35. When optical smart tags are used, a light beams generated by a tag, is detected by optical reader 31a and 31b which are essentially video cameras. The outputs of the optical readers are connected to a video processing module 32, deriving each tag location by synchronous processing of video images of the optical smart tags. Alternatively, when non optical smart tags are being used, tag location may be determined by an RF triangulation module 33 using an RF triangulation method utilizing the intersection of two lines of radio frequency signals reflected from the tag, to measure tag location. Data associated with tag location, obtained either optically or by RF triangulation, is calculated by a location server 34 to provide the location of every smart server. As indicated in the preceding section, the synchronous operational mode of the system facilitates sharing effectively limited resources like the central unit processing power by a plurality of clients like smart tags. A single clock generator 27, broadcasted over the communication and available to all the system modules, facilitates a synchronous operation of the system. The clock signal may be obtained from one of the system units or be entirely independent clock generator. Using synchronous communication reduces the probability of error rate and reduces the length of exchanged messages by staying away from frequently having to resend a message in the not as much of reliable asynchronous communication systems. A user can operate the system via a user application program 38a, 38b and 38c connected to the mediation control server 36 via an Application Program Interface (API) 37. Furthermore, communication protocol is also synchronized to the system clock and operable by the user through a terminal.

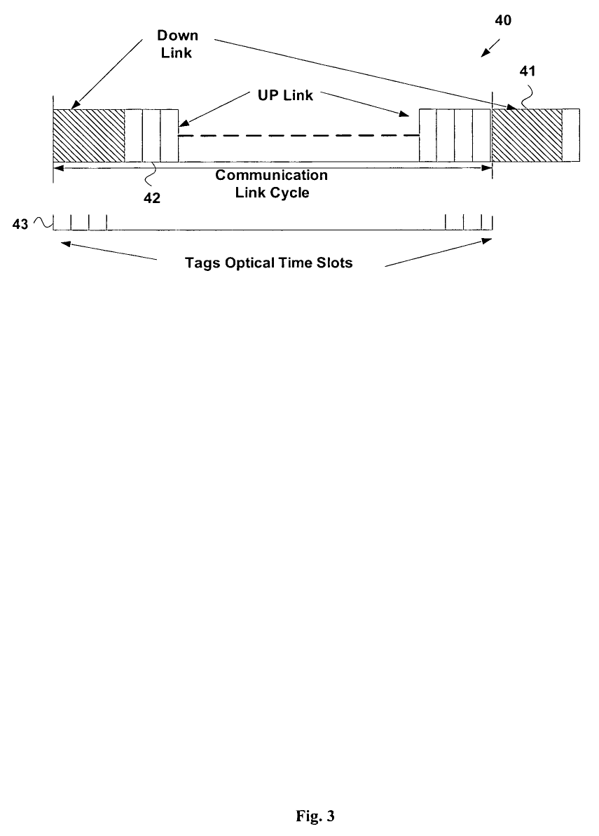

Reference is now made to FIG. 3 schematically illustrating the system timing diagram. A system communication cycle 40 is divided into a plurality of equal time slots 43 associated with the plurality of system smart tags. When optical smart tags are used, each tag turns on a signaling light during a single time slot designated by the system controller for the associated tag. When system smart tags are configured with GPS receivers, each tag GPS transmits and receives data during the corresponding time slot. System communication cycle time 40 begins with transmission of clock signal which is transmitted continuously every cycle or intermittently every few cycles. System communication cycle consists of two sections of bidirectional data transfer: A downlink data section 41 followed by an uplink data section 42. A commonly used communication cycle time may be 1sec long, however actual value of communication cycle time, up-link time and down-link time may be set to other values depending on the configuration and requirements of the tracking system. A communication cycle time begins with Radio Frequency (RF) downlink time section 41 when system central unit transmits to the smart tags an acknowledgement of receiving data, or commands to the tags, or a combination of acknowledgement and commands thereof. The second section of the system communication cycle is RF uplink time 42 when a time slot is randomly assigned to a reporting smart tag which transmits during the associated time slot data to the central unit. A tag initiating a service request transmits the service request during the next randomly selected time slot. Smart tags can search for a beacon during any available time not interfering with synchronization and receiving an acknowledging message for the service request transmission. Tag receiver is utilizing the available free time for receiving beacon transmission. Communication between the smart tags and the central system may be initiated by the smart tags or by the central system. In the Tag originated mode, the smart tags send first messages to the central system regarding tag events selected from a group of battery low power, detecting a beacon, exceeding tag sleep time limit, external interrupt occurrence or any additional event that needs to be reported. In the System originated mode, the system sends first a message to the tag responding to an application request requiring any status information of a tag.

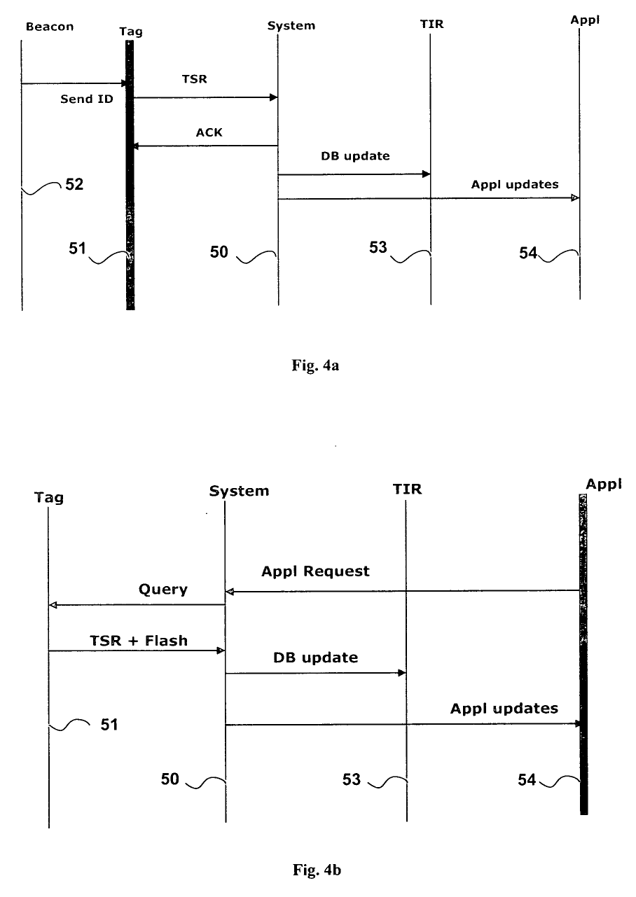

Reference is now made to FIG. 4a schematically illustrating the data flow through the communication link layers in the Tag originated mode. Beacon 52 transmits ID information that is received by all the smart tags located at the area covered by the beacon. Upon receiving ID information from the beacon, smart tag 51 transmits a Tag Service Request (TSR) to the central system 50. The system transmits back an acknowledgement of TSR receipt to tag 51, updates the data base of the Tag Information Registry (TIR) 53 with the information received from the tag and if applicable updates the application 54 with the new tag event information. Based on the received information and user instructions, the application 54 monitors the tracked assets with the affixed smart tags and controls the operation of the tracking system. This sequence of data flow is repeated by all the smart tags affixed to tracked assets and repeats for any of the tracked smart tags of the system. Every subsequent communication cycle, the procedure of data transfer between the smart tags and the central unit repeats, as long as the tracking system is operating.

Reference is made now to FIG. 4b presenting a schematically illustrating the data flow through the communication link layers in the System originated mode. Unlike the previous mode, data transfer begins with user application 54 sending an application request to the system central unit 50. The system central unit responds by initiating data exchange with an associated tag by transmitting a query to tag 51. The following data flow steps are identical to the corresponding steps listed in the preceding section. Tag 51 transmits a Tag Service Request to the system 50 and the system transmits back to the tag an acknowledgement of received message, updates TIR data base 53 and user application 54.

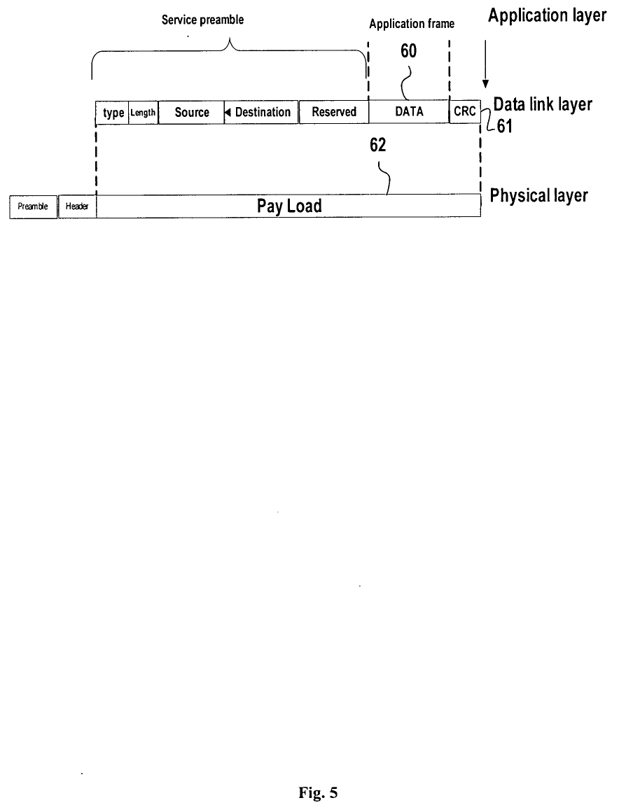

Reference is now made to FIG. 5 presenting a schematic illustration of the protocol stack which is the structure associated with the protocol layer. Application layer 60 is at the top level of the protocol. For every exchange of data with a tag, the data link layer 61 transfers an application frame of data to the application layer 60. Application data consists of messages, timing diagram and logic of communication between the smart tags and the central unit. In the data link layer 61, data is a commonly used data packet organized in three main sections: A service preamble section, a data section and a Cyclic Redundancy Correction section. The service preamble section consists of parameters of transmitted data selected from a group consisting of type of data, data length, source address and destination address. The data section can be configured in any format that is proper for the system operation. The CRC section is used for error correction of the data by including at least one bit of value determined by a checksum error correction calculation of the data section. Physical layer 62 is the lowest level of the communication link. The physical layer 62 comprises the actual data transmitted in the RF communication link. The physical layer includes a Preamble section, a header section and a data frame section. The Preamble section commonly uses a start bit indicating a beginning of data transmission. The header section is used for synchronization purposes and the data frame includes all the sections defined in data link layer 61.

1. A wireless communication system for asset tracking, comprising:
(a) a central processing and communicating unit (CPCU);
(b) a plurality of tags, each tag is assigned to an asset;
(c) a wireless communication link; and, (d) a clock generator signal;
wherein said clock generator signal is broadcasted over said communication link for synchronizing data exchange between said CPCU and said tags; and further wherein said clock signal is utilized for creating a plurality of time slots, each of said time slots is assigned to a tag.

2. The wireless communication system according to claim 1, wherein said CPCU comprising a tag information registry database.

3. The wireless communication system according to claim 1, wherein said CPCU further comprising an application interface server.

4. The wireless communication system according to claim 1, wherein said CPCU further comprising a location server.

5. The wireless communication system according to claim 1, wherein said tags comprising wireless transmitters and receivers.

6. The wireless communication system according to claim 1, wherein said tags are by default in a sleep mode.

7. The wireless communication system according to claim 1, wherein said tags further comprising a member selected from a group consisting of light emitters, GPS receivers, motion detectors, or any combination of thereof.

8. The wireless communication system according to claim 1, wherein said CPCU comprising RF triangulation transceivers.

9. The wireless communication system according to claim 1, wherein said CPCU unit comprising at least one optical reader and a video processor.

10. The wireless communication system according to claim 1, wherein said communication link comprising at least one RF beacon adapted to cover a defined area.

11. The wireless communication system according to claim 1, wherein said communication link comprising at least one base station.

12. The wireless communication system according to claim 1, comprising a protocol; said protocol further comprising a physical layer, a data link layer and an application layer; said physical layer further comprising a start preamble, a synchronizing header and an application data frame.

13. The wireless communication system according to claim 12, wherein said physical layer comprising a start preamble, a synchronizing header and an application data frame.

14. The wireless communication system according to claim 12, wherein said data link layer comprising a service preamble and an application frame; wherein said service preamble further comprising parameters selected from a group consisting of data type, data length, source address, destination address or any combination thereof.

15. The wireless communication system according to claim 12, wherein said data link layer further comprising a section of a communication cycle redundancy correction (CRC) providing an error correction and operable by a checksum of at least one bit.

16. The wireless communication system according to claim 13, wherein said data frame comprising application data and parameters of application data; wherein said parameters are selected from a group consisting of data type, data length, source address, destination address or any combination thereof.

17. A wireless communication method for asset tracking, comprising:
(a) obtaining a CPCU; a plurality of tags, each tag is assigned to an asset; a wireless communication link; and a clock signal;
(b) communicating said tags with said CPCU via said communicating link; and,
(c) broadcasting a clock signal across said communicating link,
wherein said broadcasting of a clock signal is utilized for synchronizing said communicating of said tags with said CPCU and further utilized for creating a plurality of time slots; and further wherein each of said time slots is assigned to a tag.

18. The wireless communication method according to claim 17, wherein said communicating between of all said tags with said CPCU is provided during a communication cycle time.

19. The wireless communication method according to claim 18, wherein said communicating during said communication cycle is divided to an uplink time section and to a downlink time section.

20. The wireless communication method according to claim 19, wherein said communicating uplink time section comprising time slots associated with said tags.

21. The wireless communication method according to claim 17, wherein said communicating comprising acknowledging of data receipt by said CPCU.

22. The wireless communication method according to claim 17, wherein said communicating comprising a first and second operational mode; wherein said first mode is initiated by said CPCU and said second mode is initiated by any of said tags.

23. The wireless communication method according to claim 17, comprising dividing said communication cycle time into time slots, wherein each said time slot is assigned to a single tag.

24. The wireless communication method according to claim 17, wherein said communicating between said tags and said CPCU occurring during a plurality of cycle times.
